(19) United States
(12) Patent Application Publication
(10) Pub. No.: US 2002/0085376 A1
(43) Pub. Date: Jul. 4, 2002

(54) Self extinguishing and self cleaning candle holder

(76) Inventor: Theodorus Gerhardus Potma, Zutphen (NL)

Correspondence Address: Ladas & Parry, 26 West 61st Street, New York, NY, 10023, US

(21) Appl. No.: 10/010,260

(22) Filed: Dec. 7, 2001

Related U.S. Application Data
(63) Continuation of application No. PCT/NL00/00385, filed on Jun. 6, 2000.

(30) Foreign Application Priority Data
Jun. 8, 1999 (NL) 1012255

(51) Int. Cl. F21V 35/00; F21L 19/00

(52) U.S. Cl. 362/161; 362/393; 362/396

(57) ABSTRACT

The invention is related to a candle holder for various candle diameters, whereby the candle (4) is clamped between at east two clamping surfaces or clamping edges (1, 2, 3; 1a, 2a, 3a, 4a; 1b, 2b, 3b, 4b) which are movable in respect to each other and are in general moved towards each other by means of a spring. In case of the known candle holders the candle is extinguished when the melting zone of the burning candle approches or reaches the clamping surfaces. The characteristic of the candle holder is that there is under the clamping surfaces (1, 2, 3; 1a, 2a, 3a, 4a; 1b, 2b, 3b, 4b) a candle chamber (6) which has an opening at the upper side, which opening is partly or completely closed when the clamping surfaces move towards each other.

The invention is related to a candle holder suitable for candles of various diameters, by which the candle is pressed between at least two clamping surfaces, which can also have the form of horizontal or vertical clamping edges which are movable in respect to each other and are moved toward each other in general by spring force. In case of known candle holders the candle is extinguished as soon as the melting zone of the burning candle approches or reaches the clamping surfaces.

A disadvantage of known candle holders is that in general the remaining candle stump has first to be removed before a new candle can be placed. Another disadvantage is that in such cases the clamping surfaces have to be cleaned first from superflucious candlewax or candletallow. Also often these type of candle holders do not fulfil certain aesthetic demands because the existing mechanism quickly becomes dirty by remaining candlewax.

These disadvantages can be overcome partly or completely by means of the invention.

The characteristic of the candle holder according to the invention is, that there is a candle chamber below the clamping surfaces which chamber has an opening at the upper side and which opening is purly or completely closed as the clamping surfaces move towards each other.

The invention will be explained further by means of the following figures.

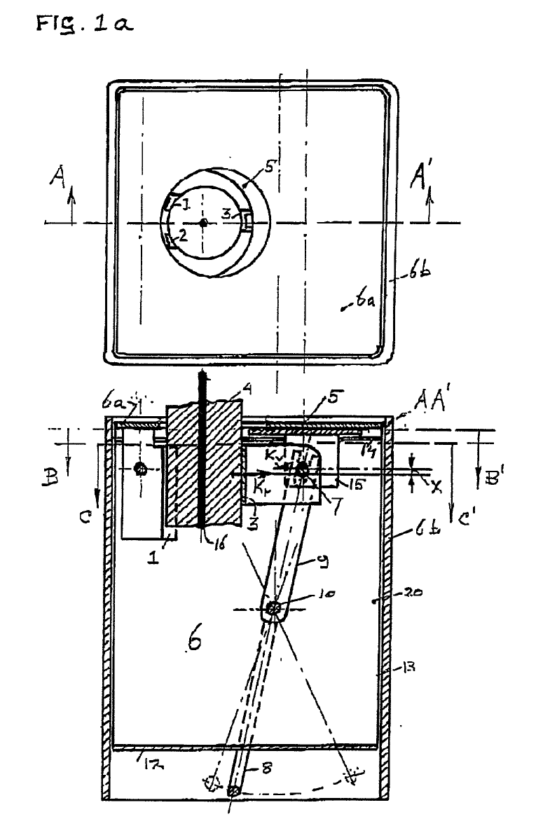

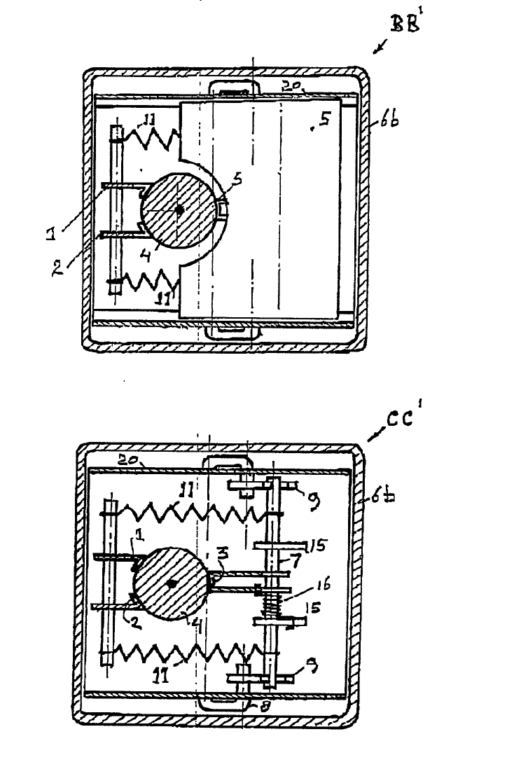

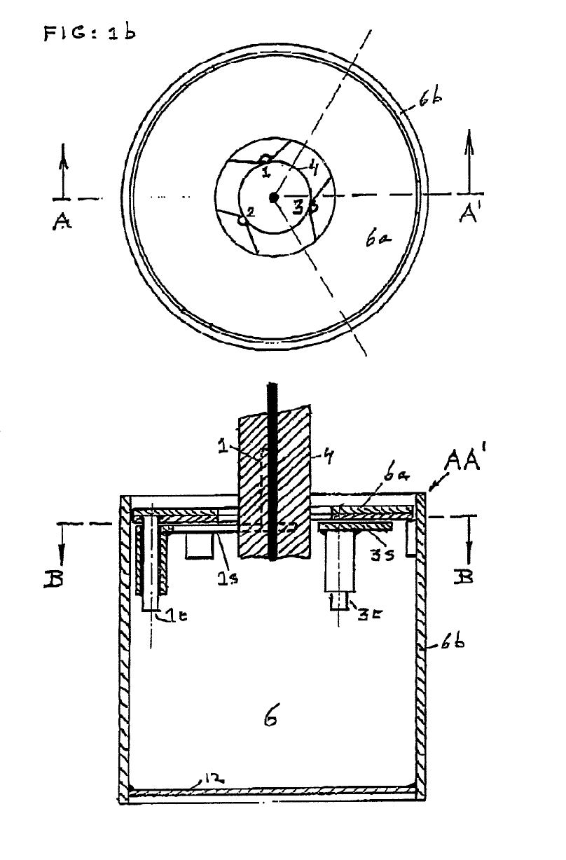

FIG. 1a and 1b: Gives a sketch of the candle holder according to the invention in which the opening of the candle chamber is closed by means of horizontal closing plates.

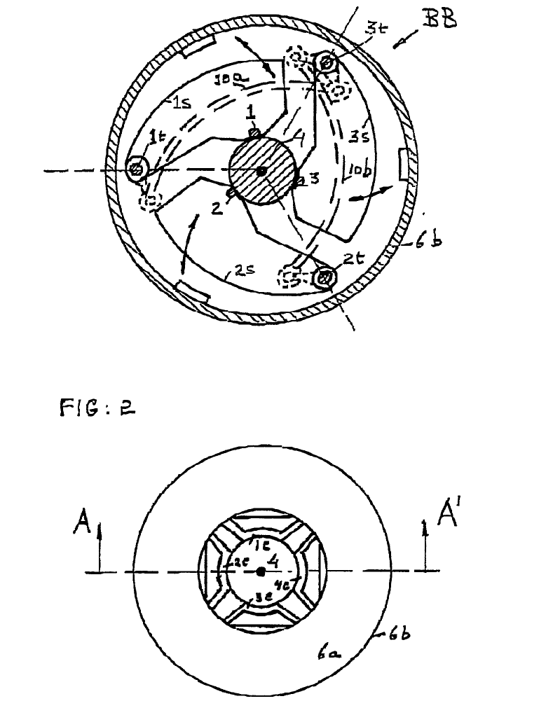

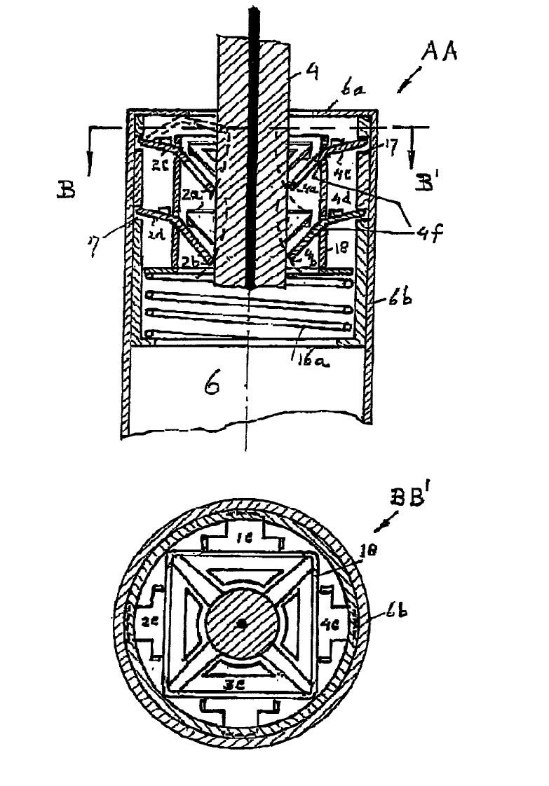

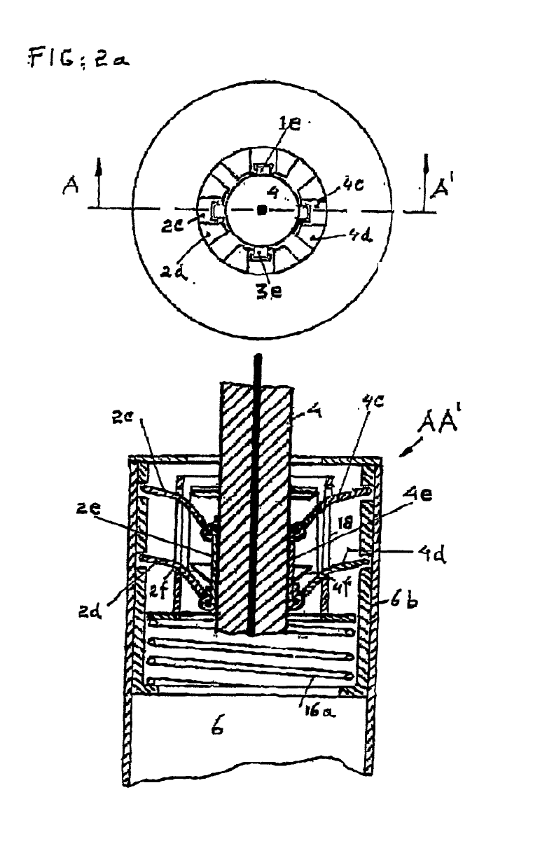

FIG. 2a and 2b: Gives an embodiment in which the opening i closed by means of closing plates which rotate around a horizontal shaft.

In FIG. 1a are 1, 2 and 3 the three vertical clamping surfaces between which the candle is clamped. The clamping surfaces 1 and 2 are here fixed to the cover 6a of the candle chamber 6b. Clamping surface 3 is in horizontal direction movable, by which the candle can be clamped between the clamping surfaces 1, 2 and 3. Clamping surface 3 is connected to closing plate 5 which is carried out as a slide with which the candle chamber 6 is closed when the moving clamping surface 3 reaches the most left position.

In case of this embodiment the vertical clamping surface 3 is turnable via the horizontal shaft 7. Shaft 7 is connected to slide 5. Cover 6a, bottom 12 and the sides of the candle chamber 6 form together one part which can be taken out via the underside. A separate cover is also possible.

The operation of the candle holder is as follows. From the moment on which the melting zone of the burning candle reaches the topside of the clamping surfaces, the working point of the resulting reaction force Kr, which is exerted by the candle on clamping surface 3, will shift downwards. This creates a rotating moment which intends to turn clamping surface 3 counter clockwise.

The turning moment is equal to Kr=Kv (is the force applied by the springs 11 on shaft 7) multiplied with the distance x. The more the melting zone is going down the more the length x will increase till at a certain moment the clamping surface 3 will turn, the candlestump will be pushed downwards and the the slide 5 will close the chamber. In case the candlestump will continue to burn it will he extinguished shortly afterwards by lack of oxygen because the candle chamber is closed. As soon as the candlestump has been pushed out downwards the clamping surface 3 will turn backwards to the starting position under influence of the torsion spring 16.

For the proper operation of the extinguishing mechanism it is not required that there are no other openings to the candle chamber 6 or that the slide 5 closes the top opening completely, as long as it is true that the combined flow passage of all existing openings which remain, after that the clamping surface 3 has reached the most left position. Is small enough to restrict the airflow to such an extend that the candlestump will be extinguished. All this means that the candle holder is self extinguishing and to a high degree self cleaning because the candlestump is pushed out downwards. After the candlestump is fallen into the candle chamber in general a new candle can be placed immediately. To place a new candle the movable clamping surface 3 is, directly or with help of a for this purpose available mechanism, moved to the right, against the spring force in FIG. 1 the help mechanism exists in a lever 8 turning around shaft 10 and moving the forks 9 which move shaft 7 and the slide 5 with the clamping surface 3 to the right. The movable clamping surface 3 makes it possible to place candles with a wide range of diameter.

In case of the described embodiment the candle is clamped between clamping surfaces 1, 2 and 3 and is free from the left edge of closing slide 5 and free from the edge of cover 6a. To realize a complete closing of the opening in the candle chamber, clamping surfaces 1, 2 and 3 are made in such a way that they can pass each other in the horizontal direction. This possibility of horizontal passing is also required because clamping surface 3 in the closed position of closing slides 5 must be able to turn backwards to the starting position.

It is also possible to use the left edge of closing plate 5 and the edge of the cover 6a as clamping edges. In that case these edge must be positioned exactly vertical above respectivily clamping surface 3 and the clamping surfaces 1,2. The vertical clamping surface 3 can also be a part of the outside circumference surface of a disk which can rotate around shaft 7. In this case it is no longer necessary that the clamping surfaces can pass each other in the horizontal direction in the situation where the left edge of closing plate 5 functions as a clamping edge and for this purpose is positioned vertical above the clamping surface 3.

In case of the embodiment described above only the right clamping surface 3 is horizontaly movable. It is also possible to use a second slide at the left end to connect the, around a horizontal shaft turntable, vertical clamping surfaces 1 an 2 to this second slide. With two or more closing plates it is possible to center the candle in respect to the candle housing. For the centering movement of the clamping surfaces use can be made of a known mechanism or use can for example be made of a separate and equaly strong spring for each closing plate. With more than one horizontal movable closing plates each with a turnable clamping surface connected to it, in which case also has to be thought of three horizontal moving closing plates as indicated in FIG. 1b, the candle stump will in general be better thrown out.

In FIG. 1b there are three vertical clamping surfaces 1, 2 and 3 in the form of a vertical pin each connected to one of three horizontal slides 1s, 2s and 3s which turn around vertical shafts 1t, 2t and 3t. These sliding plates or closing plates close, when they move towards each other, the candle holder chamber 6 but leave a small opening in the middle. The movements of the closing plates can be coupled by means of coupling levers 10a and 10b, in such a way that the sliding plates move simultaniously towards each other and the position of the candle is centered. The coupling levers are indicated in the figure by means of dotted lines. In this embodiment the vertical clamping surfaces are at the underside connected to horizontal clamping edges which form the ends of the closing plates 1s, 2s and 3s.

At the upper side of the vertical clamping surfaces 1,2 and 3 also horizontal plates (not indicated in the figure) can be connected which move along with the indicated lower closing plates, but, which do not obstruct the air flow to the upper side of the lower closing plates in closed position of the lower closing plates. These upper plates are meant to improve the clamping of the candle (in case the upper plates also have a clamping edge) and/or for aesthetical reasons.

The operation of the candle holder is a follows. As soon as the melting zone approaches the underside of the vertical opening surfaces 1, 2 and 3, the closing plates 1s, 2s and 3s will move towards each other as a result of the spring force. The spring force can result for example from tosion springs (no drawn) around the vertical shafts 1t, 2t and 3t. The part of the candlestump above the horizontal clamping edges will be squeezed together between the vertical clamping surfaces and the horizontal clamping edges. Some time later the candle stump will fall down because all the candle wax which is in contact with the clamping surfaces and edges is melted. The candle stump falls in the candle chamber 6 and extinguished because the closing plates close this chamber sufficiently. It is of importance in this case that the vertical clamping surfaces which are heated by the candle flame can transport their heat easily to the horizontal clamping edges of the closing plates, to effectuate a complete melting of the candle wax and to eliminate the possibility of sticking of the candle stump to the closing plates and the clamping surfaces. A downward inclination towards the center of the closing plates can facilitate the flowing away of melted candle wax.

Without a remaining small opening in the closed position of the closing plates the candle wax can be clamped between the closing plates. The candle stump will in this situation also be extinguished by lack of supply of candle wax to the flame and will remain hanging on the closing plates. As soon as the closing plates will be opened for the placing of a new candle the candle stump will fall into the candle chamber.

In FIG. 1b the lower closing plates close the candle chamber. In case of upper and lower closing plates the candle holder can also be carried out in such a way that only the upper closing plates will close the candle chamber. In this case there is a chance that the air supply to the burning candle stump, after the candle stump has been squeezed together, will be cut off before it is burned up sufficiently to fall down. This means that the candle stump squeezed together will be extinguished and remain in this status between the lower clamping edges, which means that the self cleaning effect is disturbed. In order to postpone in this case the squeezing together of the candle stump as much as possible it is advisable to reduce the heat transport from the upper clamping edges to the lower clamping edges by using heat isolating means.

In case of this embodiment it is als also advisable to have at the underside of the lower clamping edges surfaces with a downwards inclination in the outside direction in order to facilitate the pushing downwards of the candle stump.

In case of the embodiments with three (or more) horizontal closing plates described above it is also possible to have under each closing plate a vertical clamping surface moving along with the closing plates which vertical clamping surfaces are turnable around a horizontal shaft as is described for the vertical clamping surfaces in FIG. 1a.

FIG. 2 gives an embodiment with a tube shaped cylindrical candlehouse and with an upper set clamping edges 1a to 4a and also a lower set clamping edges 1b to 4b. The clamping edges of a set of upper plates 1c to 4c and the edges of a set of lower plates 1d to 4d which serve here as closing plates. The closing plates turn around horizontal shafts 1f to 4f which are situated close to the inner wall of the cylindrical house. As a result of the turning the clamping edges a and b move toward each other in such a way that the centerline of the candle is the same as the centerline of the candle house. The movement of the closing plates towards each other is effectuated by a vertical and upward movement of the horizontal shafts around which the closing plates turn. This is made possible because the closing plates turn around edges of horizontal slots 1f to 4f in a quadrangular tube 18 which tube can move up and down at the inside of the cylindrical candle house under influence of spring 16a. By means of this construction the clamping edges of the 2×4 closing plates move simultaniously inward and outward.

The embodiment makes it possible to move the clamping edges away from each other against the spring force by moving the quadrangular tube downwards or simply by pushing down the upper closing plates with the underside of a new candle which has to be placed in the candle holder. (Pushing down tube 18 directly means that this tube needs to have an extension at the upper side or has to be reachable in other way from the upperside.)

The form of the upper plates is here such that these plates, also in the closed inner position, do not close the opening at the upper side of the candle chamber as these plates do not have a closing function but only a supporting function and are used to clamp the candle with the upper four clamping edges. The plates also have an aesthetical function among other to cover partly for the eye the inner side of the candle house. In order to safegard that the upper plates leave enough opening, the upper plates have holes or are shaped as narrow spokelike strips (see FIG. 2a) with sufficient room between the strips.

The operation of the candle holder is as follows. In the starting position the clamping edges of the closing plates press against the candle. This centers the candle in the candle house and clampes the candle under influence of the spring 16a. As soon as the melting zone of the burning candle reaches or approches the lower clamping edges the upper and lower closing plates will move towards each other and the part of the candle stump above the lower closing plates 1d-4d will be squeezed together, whereby the oxygen supply to the candle flame is savegarded by means of the openings in the upper closing plates. Some time later, when all the candlewax around the lower closing plates is melted, the candle stump will fall into the candle chamber and will be extinguished because the lower closing plates prohibits a sufficient supply to the candle flame. In order to prevent a clamping of the candle wick between the lower closing plates these closing plates leave a small central opening free.

To improve the melting of the remaining candle stump squeezed together a good heat transport from the upper closing plates to the lower closing plates is desired and can be improved among other by connecting the upper and lower closing plates by means of hinged levers 1e to 4e which connect the upper and lower plates, as is indicated in the FIG. 2a.

A new candle can be placed by pushing with the underside of the candle downwards against the upper closing plates and pushing the candle down till the underside has passed the lower closing plates. An eventually foregoing candle stump sticking to the lower closing plates will hereby be pushed down into the candle chamber.

As is described already at the end of the description of FIG. 1b the upper closing plates can also be shaped in such a way that these plates close the opening above the candle chamber. What is said at the end of the description of FIG. 1b is here of a corresponding relevancy.

In case of described embodiments the extinguished candle stumps are stored up in the candle chamber 6 and can be taken away from time to time by means of a removable top or bottomside of the candle house.

The movement away from each other of the clamping edges and clamping surfaces can be realised by means of a two part candle house existing of an upper and a lower part, which in respect to each other can be moved or turned, whereby by means of a known mechanism the clamping edges or clamping surfaces move away from each other.

1. Candle holder by which the candle is clamped between at least two clamping surfaces of clamping edges which are horizontally and in general under spring force movable in respect to each other and whereby the candle is extinguished when the melting zone of the burning candle reaches or approches the clamping surfaces, with the characteristic, that there is a candle chamber under the clamping surface which has an opening at the upper side, which opening is partly or completely closed when the clamping surfaces move towards each other.

2. Candle holder according to conclusion 1, with the characteristic, that there are valves or closing plates which can reduce or close the opening and which move along with the movement of the clamping surfaces.

3. Candle holder according to foregoing conclusions, with the characteristic, that the preferable vertical clamping surfaces are turnable around a horizontal shaft or are part of the outside circumference surface of a disk which can rotate around a horizontal shaft.

4. Candle holder according to foregoing conclusions, with the characteristic, that all or some of the clamping surfaces are the outside edges of the closing plates.

5. Candle holder according to the foregoing conclusion, with the characteristic, that the closing plates move or slide horizontaly or are turnable around a horizontal shaft.

6. Candle holder according to one of foregoing conclusions, with the characteristic, that there are two sets of clamping surfaces or clamping edges above each other.

7. Candle holder according to the foregoing conclusion, with the characteristic, that in case of horizontaly moving closing plate the upper closing plates are connected to the underlying closing plate and in case of turnable closing plates the upper plates are connected to the lower plates via at least one vertical moving connecting element to which the closing plates are connected via a joint link.

8. Candle holder according to conclusion 7, with the characteristic, that that the upper closing plates are shaped in such a way that they admit sufficient air supply, downwards to continue the flame of a candle stump clamped between the lower clamping edges.

9. Candle holder according to conclusion 3, with the characteristic, that the clamping surfaces can pass each other in horizontal direction.
